(19) United States
(12) Patent Application Publication
(10) Pub. No.: US 2026/0085830 A1
(43) Pub. Date: Mar. 26, 2026

(54) INSTALLATION WITH SEALING DEVICE FOR A LAMP

(71) Applicant: CLARANOR, AVIGNON (FR)

(72) Inventors: Pierre LALUBIN, GRAVESON (FR); Julien DUBOIS, ROCHEFORT DU GARD (FR)

(73) Assignee: CLARANOR, AVIGNON (FR)

(21) Appl. No.: 19/110,959

(22) PCT Filed: Sep. 12, 2023
(86) PCT No.: PCT/EP2023/074955

§ 371 Date: Mar. 12, 2025

(30) Foreign Application Priority Data
Sep. 12, 2022 (FR) 2209094

(51) Int. Cl. F21V 29/58; F21V 23/06; F21V 29/57; F21V 31/00; G08B 21/18

(52) U.S. Cl. CPC F21V 29/59; F21V 23/06; F21V 29/57; F21V 31/005; G08B 21/182

(57) ABSTRACT

An installation including a lamp, a circuit for cooling the lamp, at least one electrical connection area of the lamp and at least one sealing device for sealing between the at least one electrical connection area of the lamp and the cooling circuit of the lamp. The sealing device includes an overpressure chamber positioned between the cooling chamber and the at least one electrical connection area, and two seals which are spaced apart from each other. The overpressure chamber includes an overpressure fluid, at a pressure, the pressure of the overpressure fluid being higher than the pressure of the cooling fluid present in the cooling chamber.

The invention concerns an installation equipped with a system for preventing fluid leakage between a circuit for cooling a lamp and an electrical connection of the lamp.

### PRIOR ART

Some industrial plants use lamps in product treatment processes, for example lamps that emit decontaminating radiation to decontaminate products prior to being packaged.

Some lamps heat up because of the radiation they emit, so they need to be cooled, for example by circulating a cooling fluid around the lamp walls. The lamp is at least partially surrounded by a cooling chamber through which the fluid circulates.

This is the case, for example, with flash lamps, which emit intense pulsed light (also known as IPL). In particular, they are used in industry to decontaminate objects, foodstuffs, and all kinds of products, as intense pulsed light instantly eliminates pathogenic and non-pathogenic micro-organisms.

Such flash lamps usually comprise a quartz tube, which encloses a gas. At each end of the tube, the flash lamp has two electrodes, each connected to an electrical connection, in particular a high-voltage connection.

The quartz tube is surrounded by another, coaxial tube, also made of quartz, wherein a cooling fluid (e.g. water) is circulated to limit the temperature rise of the flash lamp.

The cooling fluid must not come into contact with lamp electrodes or high-voltage connections. A sealing device, such as a gasket, is also provided between the quartz tube of the cooling circuit and the electrical connection area, where the connection between the electrode and the electrical connector is made.

Unfortunately, the gasket will eventually deteriorate, particularly because of the natural wear and tear of time. The gasket can also wear out prematurely or shift under the effect of the shockwaves that vibrate the lamp when it emits its intense flash of light: the gasket tends to peel, tear, or shift, making it less effective.

Fluid leakage then leads to undesirable phenomena. For example, in the case of water cooling, leakage leads to oxidation of the metal parts making up the electrode and connector, or even arcing between live and grounded parts. These phenomena can lead to the partial destruction of the electrical components around the lamp, or even those connected to the lamp.

### PRESENTATION OF THE INVENTION

The invention proposes a new system which aims to replace the current sealing system of flash lamps, comprising a simple gasket, and which makes it possible to prevent any leak, or to detect a leak before it causes damage.

For this purpose, the invention relates to an installation comprising a lamp, a circuit for cooling said lamp, at least one electrical connection area of the lamp that is external to said lamp, and at least one sealing device for sealing between said at least one electrical connection area of the lamp and the circuit for cooling said lamp. The lamp comprises a tube adapted to enclose a heat source and at least one electrode, adapted to generate said heat source, said at least one electrode being positioned at one end of the tube and connected to said electrical connection area, said cooling circuit comprising a cooling chamber which surrounds said lamp tube and within which a cooling fluid circulates with a cooling fluid pressure.

The installation according to the invention is remarkable in that said at least one sealing device comprises an overpressure chamber positioned between said cooling chamber and said at least one electrical connection area, said at least one sealing device further comprising two seals which are spaced apart from each other and positioned on either side of said overpressure chamber, at least one of said two seals defining a first sealing wall between the cooling chamber and the overpressure chamber, and the other seal defining a second sealing wall between the overpressure chamber and said at least one electrical connection area,
said overpressure chamber comprising an overpressure fluid, at an overpressure fluid pressure,
the pressure of the overpressure fluid being higher than the pressure of the cooling fluid present in the cooling chamber.

Constructed thusly, the installation prevents the cooling fluid from getting into the overpressure chamber if there is a leak in a seal, because the pressure in the overpressure chamber is higher than the pressure in the cooling chamber; if the seal separating them fails, the fluid in the overpressure chamber will flow into the cooling chamber, rather than the other way round.

The installation in accordance with the invention may also comprise the following features, taken separately or in combination:

Said at least one electrode comprises an electrode portion protruding from the end of the tube and the sealing device comprises an element coaxial with the lamp tube and positioned around the protruding electrode portion at the end of the tube, said element having an outer surface. In addition, the two seals grip the outer surface of said element.

According to one variant, both of said seals bear against the surface of the tube of said lamp, in the vicinity of one of the ends of the tube that houses said at least one electrode.

Advantageously, the installation comprises a solenoid valve and a control module, in particular for controlling said solenoid valve, said overpressure chamber being connected to said solenoid valve, to supply said overpressure chamber with overpressure fluid.

The installation preferably comprises a pressure sensor capable of transmitting a value of the gas pressure in said overpressure chamber to said control module.

The control module further comprises a pressure variation detection device.

Said control module is advantageously associated with a visual or audible alarm module, able to deliver a visual or audible alarm signal and able to be controlled by the control module.

The invention further comprises a method for implementing the installation as defined above.

The method comprises the following steps:
the pressure of the overpressure fluid in said overpressure chamber is monitored by means of said pressure sensor, and
if said pressure of the overpressure fluid in the overpressure chamber is less than a predetermined pressure, said solenoid valve is controlled, by means of the control module, to introduce overpressure fluid into said overpressure chamber until the pressure of the overpressure fluid in the chamber reaches an internal operating pressure of the overpressure chamber which is greater than or equal to said predetermined pressure.

In accordance with the invention, the predetermined pressure is 0.5 bar lower than the internal operating pressure of the overpressure chamber.

Preferably, the control module determines a maximum number of times said solenoid valve is triggered during a predetermined time. In addition, the control module counts, during a predetermined time, the number of times the solenoid valve has been triggered and, if said number of times the solenoid valve has been triggered is greater than or equal to said maximum number of times, the control module activates said visual or audible alarm signal.

### DESCRIPTION OF THE FIGURES

Other benefits and features of the invention will become evident upon examining the detailed description of an entirely non-limiting implementation, and from the enclosed drawings wherein:

FIG. 1 is a cross-sectional view of a schematic depiction of an installation according to a first embodiment of the invention,

FIG. 2 is an enlargement of the circle II shown in FIG. 1,

FIG. 3 is a schematic depiction of an installation according to the invention, partially showing a flash lamp, a sealing device, and other elements that may be included in an installation according to the invention to implement a method according to the invention.

### DESCRIPTION OF EMBODIMENTS OF THE INVENTION

The example that will now be described relates to the application of the invention to a flash lamp that is cooled by a cooling circuit.

It should be understood that the invention could be applied to all kinds of heat-generating lamps whose walls need to be cooled and which are connected to an electrical connection area.

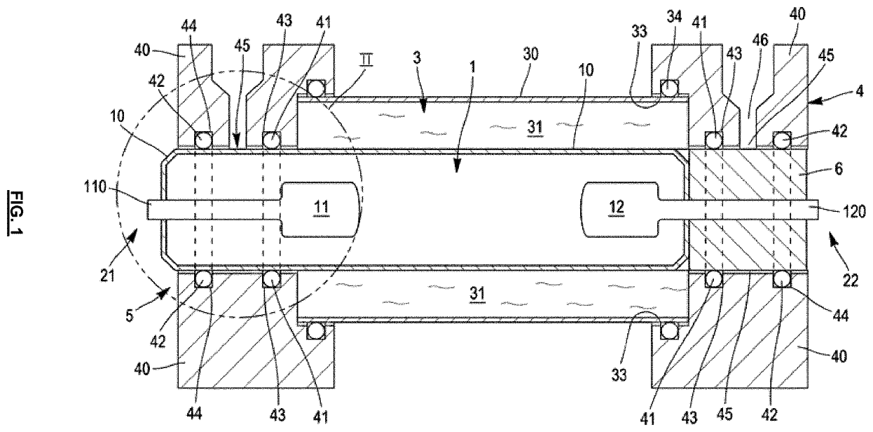

FIG. 1 schematically shows one embodiment of an installation according to the invention.

A flash lamp 1 is shown, comprising a quartz tube 10 wherein a gas (Xenon) is trapped.

The quartz tube has an electrode 11 or 12 at each of its closed ends.

Each electrode 11 and 12 is connected to an electrical connection, in particular a high-voltage electrical connection (in the example shown), to enable a flash of light (which is a heat source) to be emitted between them through the gas contained in the quartz tube: the ends 120 and 110 of the electrodes 11 and 12 are outside the quartz tube (i.e. the electrodes 11 and 12 are not entirely within the quartz tube and each have a portion which passes through the quartz tube at its end with a terminal connecting portion 120 and 110), these being the electrode portions which are connected to the power supply.

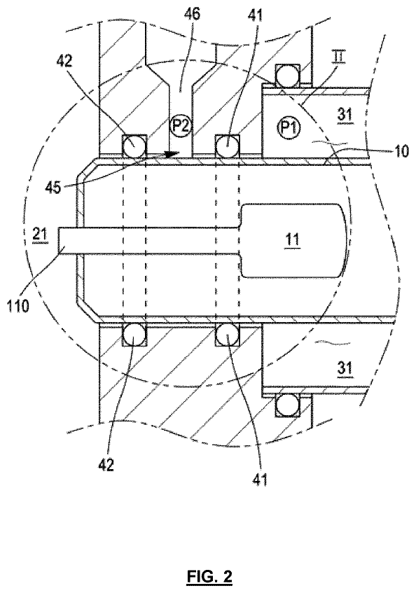

Symbolically, the areas marked 21 and 22 on FIG. 1 correspond to the (high-voltage) electrical connection areas of the installation. The electrical connection elements have not been shown in FIGS. 1 and 2 for the sake of legibility. Nevertheless, the “electrical connection area” is understood to mean an area in the immediate vicinity of the lamp which comprises both the ends 110 and/or 120 of electrodes 11 and 12 and the electrical connectors to which these ends 110 and 120 are connected.

The flash lamps 1 heat up, so it is helpful to limit their temperature rise. For example, the installation comprises a cooling circuit for the lamp 1; the lamp 1 in FIG. 1 is surrounded by a cooling chamber 3 which comprises such a circuit.

Specifically, the cooling chamber 3 comprises a quartz tube 30 which is coaxial with the tube 10 of the flash lamp 1 and surrounds the tube 10 from the outside.

A cooling area is thus defined between two coaxial walls corresponding to the walls of the tubes 10 and 30. The cooling chamber is defined between the two tubes 10 and 30 and extends between the ends of the tube 30, which bear against two lamp supports. The chamber 3 around the lamp extends on either side of the ends of tube 30: an upstream chamber for supply, opening into the chamber 3, enables it to be supplied with fluid at one of its ends, and another chamber for discharge, extending the chamber 3 downstream, opposite the upstream supply chamber, enables the cooling fluid to be collected after passing through the cooling chamber, after contact with the wall 10 of the lamp 1. The cooling fluid 31 is water, for example, and the cooling circuit ensures that the fluid 31 is always at a temperature within a defined range (usually between approximately 20 and 40° C.), or at a constant (or approximately constant) temperature in the cooling chamber 3.

It should be noted that the inlet and outlet of the cooling fluid 31 have not been shown in FIG. 1 to simplify reading.

The cooling fluid 31 is at fluid pressure P1 throughout the cooling circuit 3, including in the cooling chamber 3.

The cooling fluid must not be allowed to come into contact with the electrical connection areas 22 and 21, otherwise the lamp 1 may be damaged.

The installation further comprises a sealing device between the chamber 3 of the cooling circuit and the high-voltage connection areas 21 and 22. This device will now be described:

FIG. 1 shows two sealing devices: a first sealing device 4 shown to the left of the lamp, and a second sealing device 5 shown to the right of the lamp.

To simplify understanding of the figures, references have been kept from one example to another (between FIGS. 1, 2 and 3) for common elements repeated from one embodiment to another.

The first sealing device 4 shown in FIG. 1 is supported by an element 6 fitted around the end 120 of the electrode 12; more precisely, the element 6 is an element with an axial through-bore, suitable for being passed through by the connection end 120 of electrode 12 and integral with the electrode in a watertight manner.

The sealing device 4 comprises a block 40 which is positioned around the element 6, between the cooling chamber 3 and the high-voltage electrical connection area 22.

The cooling chamber 3 comprises a tubular wall 30, the end of which is inserted into a complementary-sized housing 33 in the block 40.

An O-ring 34 provides a seal between the outside of the quartz wall 30 of the chamber 3 and the inside surface of the housing 33 of the block 40.

The sealing device 4 further comprises two O-ring seals 41 and 42, which are partially engaged in two grooves 43 and 44 in the block 40 and are pressed against the element 6.

The grooves 43 and 44 stabilize the positions of the seals 41 and 42, facilitating their positioning and holding them in place.

It should be understood that the seals could be shaped differently from an O shape, without departing from the scope of the invention. What's more, the seals might not be inserted into grooves; they could be attached by gluing, for example, without going beyond the scope of the invention.

The seal 41 forms a sealing wall between the cooling chamber 3 and an “inter-seal” space (i.e. between the two spaced-apart seals 41 and 42), and the seal 42 forms a sealing wall between the “inter-seal” space and the high-voltage electrical connection area 22.

The “inter-seal” space forms a chamber 45 between the two seals, and this chamber 45 is designed to receive a pressurized fluid, so that the chamber 45 will be referred to as the overpressure chamber 45.

The pressurized fluid is referred to as an overpressure fluid, and in this example is a gas. More specifically, in this example, the overpressure gas is pressurized air.

It should be understood that the invention is not limited to the specific use of air to feed the overpressure chamber.

However, it is preferable for the overpressure fluid to be soluble in the cooling fluid, as will be explained later.

As can be seen in FIG. 1, a conduit 46 opens into the overpressure chamber 45, allowing the overpressure fluid (pressurized air) to be introduced into the chamber 45 until a certain pressure P2 is reached.

The pressure P2 is the pressure selected for the sealing device to perform its function: P2 is higher than the pressure P1 of the cooling fluid in the chamber 3 of the cooling circuit.

If the seal 41 between the chamber 3 of the cooling circuit and the overpressure chamber fails, since the pressure in the overpressure chamber is higher than that of the cooling fluid in the chamber 3, the overpressure fluid in the overpressure chamber 45 will leak into the chamber of the cooling circuit, rather than vice versa. In this way, the cooling fluid 31 from the cooling circuit does not enter the overpressure chamber 45 and does not come into contact with the seal 42 which separates the overpressure chamber 45 from the electrical connection area of the electrodes 11 and 12 of the lamp 1.

As mentioned above, the overpressure fluid is soluble in the cooling fluid, to avoid any adverse effects on the cooling properties of the cooling fluid.

A separator box connected to the cooling circuit is also provided for separating the cooling fluid from the overpressure fluid, downstream of the discharge device (not shown). The separator box recovers the cooling fluid so that it can run in a closed circuit. An extraction box can be provided, connected to the cooling circuit (the box has not been shown), to separate the excess pressure fluid from the cooling fluid.

The sealing device 5 shown to the left of the flash lamp 1 in FIG. 1 operates on the same principle; the block 40 of the device 5 is identical to the block 40 shown on the sealing device 4; it is a block comprising an internal axial through-opening, wherein two grooves 43 and 44 are provided on the internal periphery of the internal axial through-opening, to accommodate two O-rings 41 and 42. In addition, a conduit 46 is also provided radially to allow the introduction of gas into the space between the two O-rings 41 and 42, with the conduit 46 opening out between the two grooves 43 and 44.

The sealing device 5 comprises no element 6; the two O-rings 41 and 42 are pressed directly onto the quartz wall 10 of the flash lamp.

FIG. 2 shows that the overpressure chamber 45 takes up very little space; its purpose is to define a closed space between the two seals 41 and 42 and the surface of the lamp tube and the lower surface of block 40, to introduce pressurized gas into it so that the pressure P2 in the chamber (in this closed space) is greater than the pressure of the cooling fluid P1, so that, in the event that the seal 41 fails, the gas will flow from the overpressure chamber 45 into the chamber 3 of the cooling circuit, rather than the other direction.

In the event of failure of the seal 42, which forms a sealing wall between the overpressure chamber 45 and the high-voltage connection area 21, gas from overpressure chamber 45 escapes to the high-voltage connection area 21; this will have no effect on the operation of the lamp if the gas does not react with the material of the electrode 11 or 12.

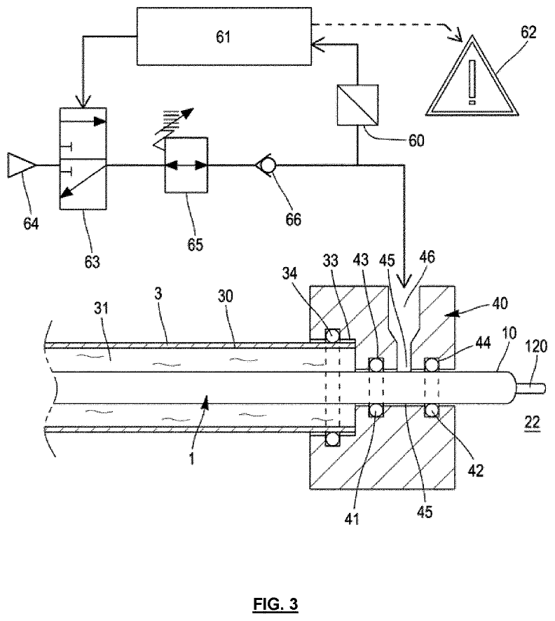

Nevertheless, this problem with the seal 42 can be detected by a pressure sensor, which will detect a drop in pressure in the overpressure chamber 45, as envisaged in another embodiment of the invention shown in FIG. 3, which will now be described.

In particular, FIG. 3 shows the installation components that complete the assembly shown in FIG. 1 or 2, to ensure the implementation of the method according to the invention.

Depicted are:
Part of the flash lamp 1, surrounded by the cooling chamber 3 of the cooling circuit,
A block 40 of the sealing device, positioned against the quartz wall 10 of the lamp 1 and against the quartz wall 30 of the cooling chamber 3,
A pressure sensor 60, which is symbolically shown outside the overpressure chamber 45; in reality, the overpressure sensor can be positioned inside the overpressure chamber or close to the chamber, in the gas intake conduit 46 wherein the pressure is substantially identical to that in the chamber 45; the position of the analog pressure sensor does not limit the invention,
A control module 61,
An alarm device 62, which can be visual or audible, to warn an operator of a sealing problem,
A gas distributor (e.g. a solenoid valve 63), connected to a pressurized gas source 64 (e.g. compressed air),
A pressure-reducing valve 65, downstream of the solenoid valve 63, coupled to a non-return valve 66.

The block 40 accommodates the end of lamp 1, and two seals 41 and 42 rest against the wall surface of the lamp 1, on either side of the inlet conduit 43 which passes through the block 40 of the sealing device.

The control module 61 performs several functions, including detecting a pressure change in the chamber and determining whether this pressure change is critical.

The pressure information in the overpressure chamber 45 is transmitted to the control module 61 by the sensor 60.

The pressure variation is considered critical if it is less than 0.5 bar of the chamber's “normal”operating pressure.

For example, if the chamber operating pressure is set at 4 bar, then the critical pressure determined by the control module is 3.5 bar; if the pressure sensor transmits a pressure value less than or equal to 3.5 bar to the control module, then the control module 61 triggers the solenoid valve 63 to inject pressurized gas into the chamber 45.

The control module 61 can also be used to count the number of times it controls the operation of the solenoid valve: if the solenoid valve is activated several times in succession, within a predetermined time interval, it can be considered that there is a leak in the overpressure chamber leading to the repeated pressure drop in the chamber 45.

Also, if the control module 61 determines that the solenoid valve has been activated more than three times in less than a day (for example), then the control module will trigger the alarm device 62, visual or audible for example, to warn the operator that the overpressure chamber of the sealing device has failed:

For example, it might be a problem with a seal 41 or 42 that needs to be changed.

It is clear from the above description how the invention ensures sealing between the lamp cooling chamber and the high-voltage connection areas of the flash lamp, and how it also enables sealing failures to be detected and an operator to be warned in the event of a sealing problem (seal wear, for example) before the lamp cooling fluid enters the high-voltage connection area.

It should be understood that the examples shown in the figures are not limiting and that the invention extends to the implementation of any equivalent means.

1-10. (canceled)

11. An installation, comprising: a lamp, a circuit for cooling said lamp, at least one electrical connection area of the lamp and at least one sealing device for sealing between said at least one electrical connection area of the lamp, external to said lamp, and the cooling circuit of said lamp, the lamp comprising a tube adapted to enclose a heat source and at least one electrode, adapted to generate said heat source, said at least one electrode being positioned at one end of the tube and connected to said connection area, said cooling circuit comprising a cooling chamber which surrounds said tube of the lamp and wherein a cooling fluid circulates with a cooling fluid pressure, said installation being wherein said at least one sealing device comprises an overpressure chamber positioned between said cooling chamber and said at least one electrical connection area, said at least one sealing device further comprising two seals which are spaced apart from each other by being positioned on either side of said overpressure chamber, at least one of said two seals defining a first sealing wall between the cooling chamber and the overpressure chamber, and the other seal defining a second sealing wall between the overpressure chamber and said at least one electrical connection area, said overpressure chamber comprising a pressurized overpressure fluid,
the pressure of the overpressure fluid being higher than said pressure of the cooling fluid present in the cooling chamber.

12. The installation according to claim 11, wherein said at least one electrode comprises an electrode portion protruding from the end of the tube and the sealing device comprises an element coaxial with the lamp tube and positioned around the protruding electrode portion at the end of the tube, said element having an outer surface, and said two seals grip the outer surface of said element.

13. The installation according to claim 11, wherein both of said seals bear against the surface of the tube of said lamp, in the vicinity of one of the ends of the tube that houses said at least one electrode.

14. The installation according to claim 11, further comprising a solenoid valve and a control module in particular for said solenoid valve, said overpressure chamber being connected to said solenoid valve, in order to supply said overpressure chamber with overpressure fluid.

15. The installation according to claim 14, further comprising a pressure sensor capable of transmitting a value of the pressure of the gas in said overpressure chamber to said control module.

16. The installation according to claim 15, wherein said control module comprises a pressure variation detection device.

17. The installation according to claim 14, wherein said control module is associated with a visual or audible alarm module, capable of delivering a visual or audible alarm signal and capable of being controlled by the control module.

18. A method for implementing the installation according to claim 16, comprising the following steps:
the pressure of the overpressure fluid in said overpressure chamber is monitored by means of said pressure sensor, and
if said pressure of the overpressure fluid in the overpressure chamber is less than a predetermined pressure, said solenoid valve is controlled, by means of the control module, to introduce overpressure fluid into said overpressure chamber until the pressure of the overpressure fluid in the chamber reaches an internal operating pressure of the overpressure chamber which is greater than or equal to said predetermined pressure.

19. The method according to claim 18, wherein said predetermined pressure is 0.5 bar lower than said internal operating pressure of said overpressure chamber.

20. The method according to claim 18,
wherein the control module determines a maximum number of times said solenoid valve is triggered during a predetermined time,
wherein the control module counts, during a predetermined time, the number of times the solenoid valve has been triggered and, if said number of times the solenoid valve has been triggered is greater than or equal to said maximum number of times, the control module activates said visual or audible alarm signal.
